(19) United States
(12) Patent Application Publication
(10) Pub. No.: US 2018/0226011 A1
(43) Pub. Date: Aug. 9, 2018

(54) DISPLAY PANEL AND DRIVING SYSTEM

(71) Applicant: Shenzhen China Star Optoelectronics Technology Co., Ltd., Shenzhen, Guangdong (CN)

(72) Inventors: Dekang ZENG, Shenzhen, Guangdong (CN); Fengcheng XU, Shenzhen, Guangdong (CN); Dongsheng GUO, Shenzhen, Guangdong (CN)

(73) Assignee: Shenzhen China Star Optoelectronics Technology Co., Ltd., Shenzhen, Guangdong (CN)

(21) Appl. No.: 15/310,726

(22) PCT Filed: Sep. 21, 2016
(86) PCT No.: PCT/CN2016/099547

§ 371 Date: Nov. 11, 2016

(30) Foreign Application Priority Data
Jul. 28, 2016 (CN) 201610605940.2

(51) Int. Cl. G09G 3/20

(52) U.S. Cl. CPC G09G 3/2081; G09G 2310/0291; G09G 2310/08

(57) ABSTRACT

The present disclosure proposes a driving system to drive a display panel. The driving system includes a DC-DC inverter, a timing controller controlling the DC-DC inverter to output square waveform signal and drawing pixel grayscale data from received frame signal, and a source driver, comprising an active integrating circuit, the active integrating circuit outputting grayscale voltages based on the pixel grayscale data and the square waveform signal. The driving system is simplified to reduce cost, because of the use of the active integrating circuit of the source driver.

### BACKGROUND

### 1. Field of the Disclosure

The present disclosure relates to a display field, and more specifically, to a display panel and a driving system to drive the display panel.

### 2. Description of the Related Art

As shown in FIG. 1, a conventional driving system 100 for driving a display panel includes a DC/DC inverter 101, a gamma correction circuit 102, a timing controller 103, a source driver 104, and a display panel 105. The source driver 104 includes a resistance string 106, a digital-to-analog converter (DAC) 107. Since the layout of the resistance string 106 and DAC 107 occupy large areas as shown in FIG. 2, the conventional driving system 100 is complex and expensive.

### SUMMARY

The present disclosure proposes a driving system to drive a display panel to overcome defect of the related art. According to an embodiment of the present disclosure, a driving system to drive a display panel includes a DC-DC inverter, a timing controller controlling the DC-DC inverter to output square waveform signal and drawing pixel grayscale data from received frame signal, and a source driver. The source driver includes an active integrating circuit which outputs grayscale voltages based on the pixel grayscale data and the square waveform signal.

Optionally, the active integrating circuit comprises a programmable resistor and an operational amplifier.

Optionally, a negative terminal of the operational amplifier is coupled to the programmable resistor and a positive terminal of the operational amplifier is coupled to the square waveform signal.

Optionally, the active integrating circuit further comprises a capacitor coupled between the negative terminal and positive terminal of the operational amplifier.

Optionally, resistances of the programmable resistor are variable depending on various pixel grayscale data.

Optionally, the grayscale voltages outputted by the operational amplifier are determined by the pixel grayscale data and the square waveform signal.

Optionally, the grayscale voltages outputted at the output terminal of the operational amplifier is calculated based on an equation:

$${V}_{o} = {V}_{ref} - \frac{1}{RC} \int {V}_{REF} ( t ) dt ,$$

where V_{O} indicates the grayscale voltages outputted at the output terminal of the operational amplifier, V_{ref} indicates a magnitude of the square waveform signal, R indicates to the resistance of the programmable resistor, C indicates capacitance of the capacitor, V_{REF} indicates square waveform signal, t indicates time period.

The merit of the driving system to drive a display panel of the present disclosure is that the driving system to drive the display panel is simplified, because the use of the active integrating circuit of the source driver in lieu of a Gamma correction module and a DAC module can reduce size of a printed circuit board, thereby lowering the cost.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a driving system to driving a display panel according to a related art.

FIG. 2 shows a resistance string and a DAC circuit of the driving system to driving a display panel according to a related art.

FIG. 3 illustrates a driving system to driving a display panel according to an embodiment of the present disclosure.

FIG. 4 illustrates an active integrating circuit according to an embodiment of the present disclosure.

FIG. 5A illustrates a waveform of a square waveform signal according to an embodiment of the present disclosure.

FIG. 5B illustrates waveforms of grayscale voltages according to an embodiment of the present disclosure.

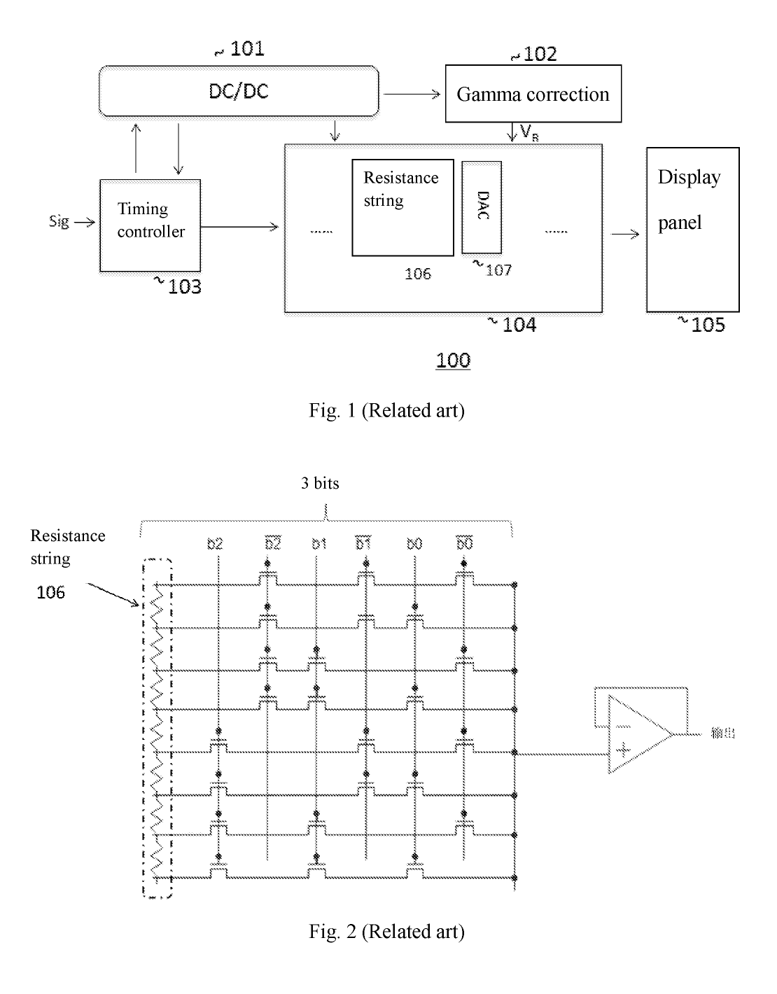

### DETAILED DESCRIPTION OF THE PREFERRED EMBODIMENTS

For better understanding embodiments of the present disclosure, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

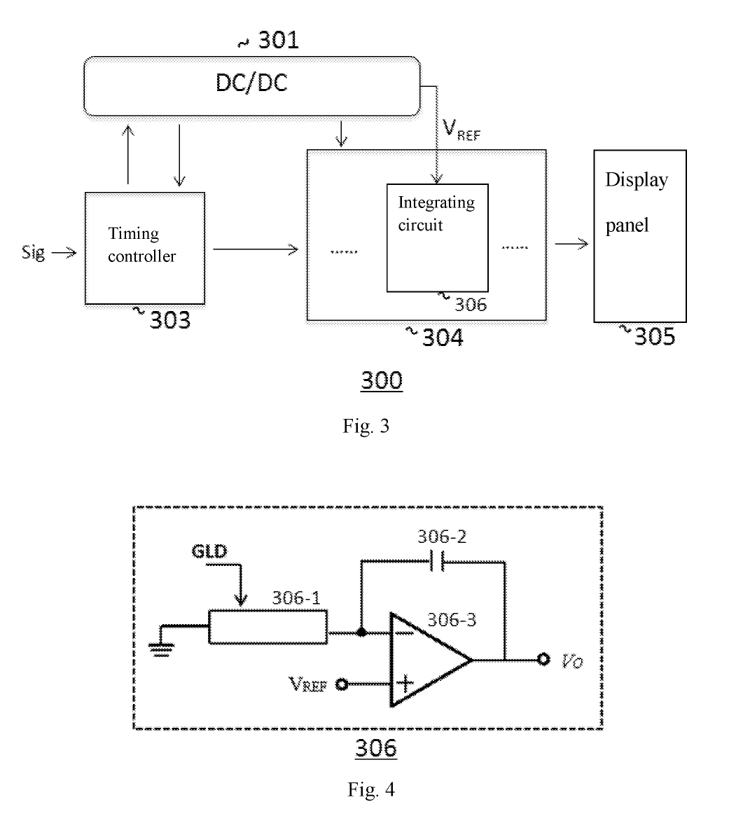

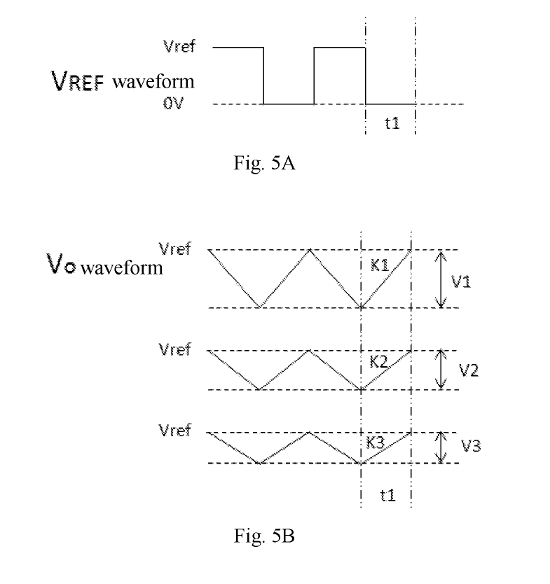

Refer to FIG. 3 illustrating a driving system 300 to drive a display panel according to an embodiment of the present disclosure. The driving system 300 includes a DC/DC inverter 301, a timing controller 303, a source driver 306 having an active integrating circuit 306, and a display panel 305.

The DC/DC inverter 301 can supply power to all the modules of the driving system 300. The timing controller 303 outputs signal in form of square waveform with a predetermined duty cycle. The signal is converted to square waveform signal V_{REF} with a magnitude V_{ref} (e.g. as shown in FIG. 5A) using the DC/DC inverter 301. The timing controller 303 captures pixel grayscale data GLD associated to various colors in channels from received frame signal Sig. The active integrating circuit 306 of the source driver 304 outputs grayscale voltages based on the square waveform signal V_{REF} and pixel grayscale data GLD. The display panel 305 shows various grayscales based on the outputted grayscale voltages. The active integrating circuit 306 is introduced in the following paragraphs in conjunction with FIG. 4.

As illustrated in FIG. 4, the active integrating circuit 306 is implemented by an operational amplifier 306-3 having a negative terminal coupled to ground via a programmable resistor 306-1, a positive terminal coupled to the square waveform signal V_{REF}, and an output terminal coupled to the negative terminal via a capacitor 306-2 with a constant capacitance. The grayscale voltage Vₒ outputted at the output terminal of the operational amplifier 306-3 is calculated based on the following Equation 1:

$${V}_{o} = {V}_{ref} - \frac{1}{RC} \int {V}_{REF} ( t ) dt , \qquad ( Equation 1 )$$

where V_{ref} indicates a magnitude of the square waveform signal, R indicates to the resistance of the programmable resistor 306-1, C indicates capacitance of the capacitor 306-2, V_{REF} indicates square waveform signal, t indicates time period. The grayscale voltage Vₒ shows a triangle waveform based on the Equation 1, because the variable resistance of the programmable resistor 306-1 is variable depending on the pixel grayscale data GLD. Referring to Equation 1 and FIGS. 5A and 5B, during a time period t1, a slope of the triangle waveform, e.g. K1-K3 shown in FIG. 5B, is varied as the resistance R of the programmable resistor 306-1, so that various grayscale voltages Vo, e.g. V1-V3 illustrated in FIG. 5B, are outputted. Accordingly, the grayscale voltages are obtained based on the variable slope of the triangle waveform by means of adjustments of the resistance R of the programmable resistor 306-1. The display panel 305 shows corresponding grayscales based on the outputted grayscale voltages Vₒ.

In accordance with the present disclosure, the driving system to drive the display panel is simplified, because the use of the active integrating circuit of the source driver in lieu of a Gamma correction module and a DAC module can reduce size of a printed circuit board, thereby lowering the cost.

While the invention has been described by way of example and in terms of the preferred embodiments, it is to be understood that the invention is not limited to the disclosed embodiments. To the contrary, it is intended to cover various modifications and similar arrangements.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. A driving system to drive a display panel, comprising:
a DC-DC inverter;
a timing controller, controlling the DC-DC inverter to output square waveform signal and drawing pixel grayscale data from received frame signal;
a source driver, comprising an active integrating circuit, the active integrating circuit outputting grayscale voltages based on the pixel grayscale data and the square waveform signal.

2. The driving system as claimed in claim 1, wherein the active integrating circuit comprises a programmable resistor and an operational amplifier.

3. The driving system as claimed in claim 2, wherein a negative terminal of the operational amplifier is coupled to the programmable resistor and a positive terminal of the operational amplifier is coupled to the square waveform signal.

4. The driving system as claimed in claim 3, wherein the active integrating circuit further comprises a capacitor coupled between the negative terminal and positive terminal of the operational amplifier.

5. The driving system as claimed in claim 4, wherein resistances of the programmable resistor are variable depending on various pixel grayscale data.

6. The driving system as claimed in claim 5, wherein the grayscale voltages outputted by the operational amplifier are determined by the pixel grayscale data and the square waveform signal.

7. The driving system as claimed in claim 6, wherein the grayscale voltages outputted at the output terminal of the operational amplifier is calculated based on an equation:
$${V}_{o} = {V}_{ref} - \frac{1}{RC} \int {V}_{REF} ( t ) dt ,$$
where V_{O} indicates the grayscale voltages outputted at the output terminal of the operational amplifier, V_{ref} indicates a magnitude of the square waveform signal, R indicates to the resistance of the programmable resistor, C indicates capacitance of the capacitor, V_{REF} indicates square waveform signal, t indicates time period.

8. A display panel comprising a driving system, wherein the driving system comprises:
a DC-DC inverter;
a timing controller, controlling the DC-DC inverter to output square waveform signal and drawing pixel grayscale data from received frame signal;
a source driver, comprising an active integrating circuit, the active integrating circuit outputting grayscale voltages based on the pixel grayscale data and the square waveform signal.

9. The display panel as claimed in claim 8, wherein the active integrating circuit comprises:
a programmable resistor;
an operational amplifier, comprising a negative terminal coupled to the programmable resistor and a positive terminal coupled to the square waveform signal; and
a capacitor, coupled between the negative terminal and positive terminal,
wherein resistances of the programmable resistor are variable depending on various pixel grayscale data, and the grayscale voltages outputted by the operational amplifier are determined by the pixel grayscale data and the square waveform signal.

10. The display panel as claimed in claim 9, wherein the grayscale voltages outputted at the output terminal of the operational amplifier is calculated based on an equation:
$${V}_{o} = {V}_{ref} - \frac{1}{RC} \int {V}_{REF} ( t ) dt ,$$
where V_{O} indicates the grayscale voltages outputted at the output terminal of the operational amplifier, V_{ref} indicates a magnitude of the square waveform signal, R indicates to the resistance of the programmable resistor, C indicates capacitance of the capacitor, V_{REF} indicates square waveform signal, t indicates time period.
